(19) United States
(12) Patent Application Publication
(10) Pub. No.: US 2018/0137591 A1
(43) Pub. Date: May 17, 2018

(54) METHOD AND SYSTEM FOR REGULATING REQUEST AND PROVISION OF RESOURCES FOR TRANSACTIONS IN SMART CITY

(71) Applicant: Wipro Limited, Bangalore (IN)

(72) Inventor: Vikas S. Shah, Phoenixville, PA (US)

(21) Appl. No.: 15/353,401

(22) Filed: Nov. 16, 2016

(51) Int. Cl. G06Q 50/26; G06Q 10/06

(52) U.S. Cl. CPC G06Q 50/26; G06Q 10/06315

(57) ABSTRACT

The present disclosure discloses a method and a system for regulating request and provision of resources in a smart city. The method comprises identifying transactions of resources, involving request and provision of the resources, identifying contexts for the resources, determining an equation for a ratio of the request and provision corresponding to the contexts, where a threshold boundary is set for the ratio, determining rules for performing the transactions, enforcing the rules on the transactions, monitoring the transactions and thereby generating monitoring data for real-time analysis, computing present value of the ratios corresponding to resources in smart city, and adjusting the values of the associated contexts within the ratio to update the predefined threshold boundary of the resources in real-time, thereby regulating the request and provision, associated with the transactions corresponding to the resources.

### FIELD

The present disclosure relates to field of resource governance. Specifically, but not exclusively, the present disclosure relates to a method and a system for regulating events associated with transaction of resources in a smart city.

### BACKGROUND

Resource governance is one of the prime fields which is under scrutiny. Several systems have been implemented to manage resources effectively in a region. Resource management now being widely used in implementing the concept of smart city. Traditionally, performance of transactions of resources in a region is based on performance indicators and communication technology. Many organizations are developing technical reports on Key Process Indicators (KPI) that monitor various fields such as transportation, security, safety, healthcare, manufacturing, etc. The KPIs are standardized for delivering performance during existing operations of transactions in the region. However, the standards do not suggest any action plan or governance in terms of how to achieve the target indicator value. More specifically, traditional systems do not provide contextualization in terms of specific set of products.

Although the traditional systems provide methodology to maintain a request to provisioning ratio for performing transactions of resources, the ratio is not timely updated. Thus, infrequent updates of the ratio affect efficiency of such transactions and thereby decreases performance of the smart city.

Measuring success at city level is complicated by the relative immaturity of most smart city initiatives and the difficulty of linking initiatives to supply and demand issues. The governance of the ratio needs to advance, manage, and keep pace with the expected growth even in consideration of most granular offerings of the city infrastructure.

### SUMMARY

In an embodiment, the present disclosure is a method for regulating request and provisioning of resources associated with transactions in smart city. The method comprises identifying, by a smart city resource governance system, one or more transactions of one or more resources, involving request and provision of the one or more resources, identifying one or more contexts for each of the one or more resources, determining an equation for a ratio of the request and provision corresponding to each of the one or more contexts, wherein a predefined threshold boundary is set for each of the ratio, analysing relationship between the ratio corresponding to each of the one or more contexts, determining one or more rules for performing the one or more transactions, deriving one or more constraints to the one or more transactions associated with the request and provision of the one or more resources, enforcing the one or more rules on the one or more transactions by applying the one or more constraints to the one or more transactions, for regulating the request and provision associated with the one or more transactions.

In an embodiment of the present disclosure, a system for regulating request and offer of resources associated with transactions in a smart city is disclosed. The system comprises a processor and a memory, communicatively coupled with the processor, comprising processor executable instructions. The processor is configured to identify one or more transactions of one or more resources, involving request and provision of the one or more resources, identify one or more contexts for each of the one or more resources, determine an equation for a ratio of the request and provision corresponding to each of the one or more contexts, wherein a predefined threshold boundary is set for each of the ratio, analysing relationship between the ratio corresponding to each of the one or more contexts, determine one or more rules for performing the one or more transactions, derive one or more constraints to the one or more transactions associated with the request and provision of the one or more resources, enforce the one or more rules on the one or more transactions by applying the one or more constraints to the one or more transactions, for regulating the request and provision associated with the one or more transactions.

A non-transitory computer readable medium including instructions stored thereon that when processed by at least one processor cause a device to perform operations comprising identifying one or more transactions of one or more resources, involving request and provision of the one or more resources, identifying one or more contexts for each of the one or more resources based on one or more parameters, determining an equation for a ratio of the request and provision corresponding to each of the one or more contexts, wherein a predefined threshold boundary is set for each of the ratio, analysing relationship between the ratio corresponding to each of the one or more contexts, determining one or more rules for performing the one or more transactions based on the analysed relationship, deriving one or more constraints to the one or more transactions associated with the request and provision of the one or more resources based on the predefined threshold boundary, the one or more rules, and type of the one or more transactions and enforcing the one or more rules on the one or more transactions by applying the one or more constraints to the one or more transactions, for regulating request and provision of resources associated with transactions.

### BRIEF DESCRIPTION OF THE DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 shows a diagram of a smart city and a system in the smart city for regulating request and provision of resources associated with transactions in accordance with some embodiments of the present disclosure;

FIG. 2 shows internal architecture of a system for regulating request and provision of resources associated with transactions in accordance with embodiments of the present disclosure;

FIG. 3 shows an exemplary flow chart illustrating methodological steps for regulating request and provision of resources associated with transactions in accordance with embodiments of the present disclosure;

FIG. 4 shows a generic computer system for regulating request and provision of resources associated with transactions in accordance with embodiments of the present disclosure;

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relate to a smart city resource governance system or computing device for regulating request and provision of resources associated with transactions. The smart city resource governance system identifies one or more transactions of one or more resources, occurring in a smart city. Further, the smart city resource governance system identifies one or more contexts related to each of the one or more resources. Here, each of the one or more contexts is associated with request and provision of the one or more resources. The smart city resource governance system inserts the one or more contexts to the equation and monitors the one or more transactions. Further, the smart city resource governance system regulates the equation based on the monitoring of the one or more transactions.

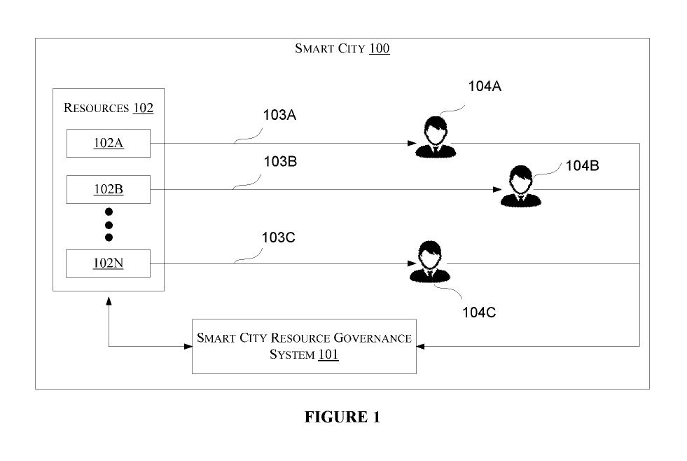

FIG. 1 shows a smart city 100 comprising a smart city resource governance system 101 for regulating request and provision of resources associated with transactions. The smart city 100 further comprises resource 102A, resource 102B, . . . , resource 102N. The resource 102A, resource 102B, . . . , resource 102N can be collectively represented as one or more resources 102 hereinafter throughout this disclosure. 103A, 103B and 103C indicates transactions of the one or more resources 102. The transactions 103A, 103B and 103C can be collectively represented as one or more transactions 103 hereinafter throughout this disclosure. Further, 104A, 104B and 104C indicates users. The user 104A, 104B and 104C can be collectively represented as one or more users 104 hereinafter throughout this disclosure. Each of the one or more transactions 103 occur when at least one of the one or more users 104 requests for at least one of the one or more resources 102. Further, the one or more transactions 103 are facilitated by provisioning the one or more resources 102 to corresponding one or more users 104 requesting the one or more resources 102. The smart city resource governance system 101 identifies the one or more transactions 103 of the one or more resources 102. Further, the smart city resource governance system 101 identifies one or more contexts for each of the one or more resources 102. For the identified one or more contexts, a ratio of request and provision of the one or more resources 102 is associated. For each ratio, a predefined threshold boundary is set. Using the one or more contexts associated with one or more resources, an equation relating to computation of request to provision ratio is determined for corresponding one or more resources in smart city 100. Then, the smart city resource governance system 101 determines one or more rules and constraints for enforcing on the one or more transactions 103. Further, the one or more transactions 103 are monitored and based on the monitoring, the smart city resource governance system 101 computes values of each of the ratio. Further, the smart city resource governance system 101 inserts additional contexts based on the monitoring. Lastly, the smart city resource governance system 101 alters the equation and adjusts the values to update the predefined boundary in real-time. Thus, the smart city resource governance system 101 regulates request and provision of the one or more resources 102 in a smart city 100.

In an embodiment, the one or more resources 102 may include, but are not limited to, fruits, vegetables, raw materials, stationeries, construction equipment, etc. The one or more resources 102 may include any resource 102 that forms a part of the smart city 100.

In an embodiment, the request may be made by the one or more users 104, an industry, an enterprise or any person or thing that requires the one or more resources 102.

In an embodiment, the one or more transactions 103 indicate provision of the one or more resources 102 requested by the one or more users 104. The one or more transactions 103 are made such that the provision of the one or more resources 102 are always equal or greater than the amount of the one or more resources 102 requested.

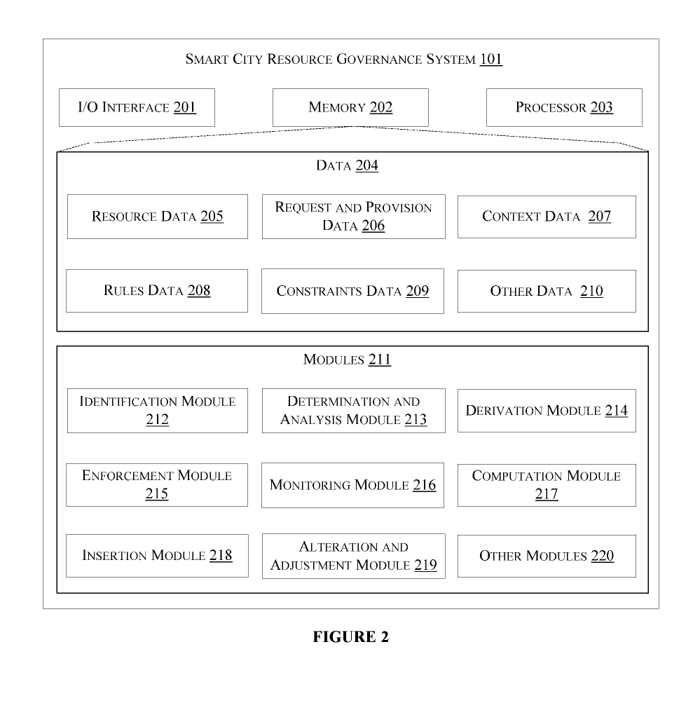

FIG. 2 shows internal architecture of the smart city resource governance system 101. The smart city resource governance system 101 may include at least one central processing unit (“CPU” or “processor”) 203 and a memory 202 storing instructions executable by the at least one processor 203. The processor 203 may comprise at least one data processor for executing program components for executing user 104 or system-generated requests. User 104 here refers to one or more users 104 as defined in the present disclosure. The memory 202 is communicatively coupled to the processor 203. The smart city resource governance system 101 further comprises an Input/Output (I/O) interface 201. The I/O interface 201 is coupled with the processor 203 through which an input signal or/and an output signal is communicated.

In an embodiment, one or more data 204 may be stored within the memory 202. The one or more data 204 may include, for example, resource data 205, request and provision data 206, context data 207, rules data 208, constraints data 209 and other data 210. The resource data 205 includes type of resource, availability of resource, providers of the resource, consumer of the resource, equation of the ratio corresponding to the resource, value of the threshold boundary computed based on the ratio, etc. The rule data 208 includes local, national, and global rules associated with the one of more resources.

In an embodiment, the request and provision data 206 includes number of requests made, number of provisions made to the requests, type of one or more resources 102 requested, type of provision, etc.

In an embodiment, the context data 207 includes type of contexts, context relevance with the one or more resources 102, etc. For example, consider a food supply chain management. Consider fruits and vegetables are the one or more resources 102. The contexts related to the fruits and vegetables may be canned food, brand, provider, percentage of recycle material, percentage of wastage material, etc.

In an embodiment, the rules data 208 includes one or more rules for performing the one or more transactions 103 of the one or more resources 102. The one or more rules define how the one or more transactions 103 have to be performed. In an embodiment, the one or more rules are monitored and updated based on performance of the one or more transactions 103. Updating the one or more rules assists in regulating the request and provision of the one or more resources 102 associated with the one or more transactions 103.

In an embodiment, the constraints data 209 include one or more constraints that are imposed on the one or more transactions 103. The one or more constraints are imposed based on the one or more rules defined for corresponding one or more resources 102 and predefined threshold boundary for corresponding one or more resources 102.

The other data 210 may be used to store data, including temporary data and temporary files, generated by modules 211 for performing various functions of the smart city resource governance system 101.

In an embodiment, the one or more data 204 in the memory 202 is processed by modules 211 of the smart city resource governance system 101. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The said modules 211 when configured with the functionality defined in the present disclosure will result in a novel hardware.

In one implementation, the modules 211 may include, for example, identification module 212, determination and analysis module 113, derivation module 214, enforcement module 215, monitoring module 216, computation module 217, insertion nodule 218, alteration and adjustment module 219 and other modules 220. It will be appreciated that such aforementioned modules 211 may be represented as a single module or a combination of different modules.

In an embodiment, the identification module 212 identifies the one or more transactions 103 of the one or more resources 102. Here, each of the one or more transactions 103 involves request and provision of the one or more resources 102. Further, the identification module 212 identifies the one or more contexts for each of the one or more resources 102 based on one or more parameters. The one or more parameters comprises at least one of one or more participants of smart city resource governance system 101, characteristics of the one or more resources 102, association of the one or more participants, coverage vicinity of the one or more participants, and utilization of the one or more resources 102 by one or more participants. Here, the one or more contexts are used to regulate ratio of the request and provision of the one or more resources 102.

In an embodiment, the determination and analysis module 213 determines the equation for the ratio of the request and provision corresponding to the one or more resources 102 based on each of the one or more contexts associated with the one or more resources 102. Here, a predefined threshold boundary is set for the ratio of the request and provision corresponding to the one or more resources 102 based on threshold value for each of the one or more contexts associated with the one or more resources 102. In an embodiment, the equation of the ratio of the request and provision is determined by equating the ratio of request and provision based on at least one of the one or more contexts, the one or more transactions 103 performed by the one or more participants, and the one or more parameters. Here, the one or more participants may include manufacturers of the one or more resources, distributors of the one or more resources, consumers of the one or more resources or retailers. Further, the determination and analysis module 213 analyses relationship between the ratio corresponding to each of the one or more contexts. Here, the relationship conveys interdependency of the one or more resources 102 on each other. Also, the relationship helps determine external impact on the one or more resources 102. For example, consider bikes and helmets as two resources. When there is an increase in requirement of bikes in a locality, probability of increase in requirement of helmets is very high. Here, the requirement of helmets is dependent on the requirement of bikes. Furthermore, the determination and analysis module 213 determines one or more rules for performing the one or more transactions 103 based on the analysed relationship. The one or more rules define how the one or more transactions 103 have to be performed.

In an embodiment, the derivation module 214 derives the one or more constraints to the one or more transactions 103 associated with the request and provision of the one or more resources 102. The one or more constraints are derived based on the predefined threshold boundary, the one or more rules, and type of the one or more transactions. Considering an example of canned vegetables, the one or more contexts may be daily consumption, daily supplies, brands, providers, stock, items returned, average retention, recycle indicator, wastage indicator, preservative level, etc. Here, if the one or more rules does not allow a particular brand of canned vegetable to be delivered to a particular retailer on a particular day, and if the canned vegetable is provided to the retailer on a different day, the retailer would either deny or return the canned vegetable. Here, supply of brand of canned vegetable is dependent on the one or more rules. Likewise, the one or more constraints are based on the one or more rules, type of the one or more transactions associated with resource, and predefined threshold boundary.

In an embodiment, the enforcement module 215 enforces the one or more rules on the one or more transactions 103 by applying the one or more constraints to the one or more transactions 103. Here, the one or more constraints are automatically applied on the one or more transactions 103 based on the predefined threshold boundary. Here, for a given type of one or more resource 103, the one or more constraints are applied automatically on the one or more transactions 103 for the one or more resources 102. The one or more constraints are applied based on the predefined threshold boundary corresponding to the ratio associated with the one or more contexts associated with the one or more resources 102.

In an embodiment, the monitoring module 216 monitors the one or more transactions 103. Further, the monitoring module 216 generates monitoring data for analysis. The monitoring data includes information related to completion of the one or more transactions 103, correctness of the one or more transactions 103, sufficiency of the one or more transactions 103, etc. In an embodiment, the request and provision associated with the one or more resources 102 are monitored based on the equation of the ratio of request and provision. In an embodiment, the monitoring data forms a part of the other data 210.

In an embodiment, the computation module 217 computes present value of each of the ratio corresponding to each of the one or more resources 102 based on the analysis of the monitoring data. Here, the value refers to present value of the request to provision ratio of the one or more resources 102 in smart city 100. The values are computed at runtime to regulate the request and provision of the one or more resources 102 associated with the one or more transactions 103.

In an embodiment, the insertion module 218 inserts one or more additional contexts for each of the one or more resources 102 based on the one or more parameters and the monitored data. The one or more additional contexts are inserted to mitigate transaction loss based on the analysis of the monitored data. Here, transaction loss may include wastage of the one or more resources 102, over-supply of the one or more resources 102, under-supply of the one or more resources 102, wrong supply of the one or more resources 102, etc. Further, an equation is derived based on the one or more additional contexts.

In an embodiment, the alteration and adjustment module 219 alters the equation of the ratio for the corresponding request and provision with the one or more additional contexts. The insertion of the one or more additional contexts may alter the predefined threshold boundary. Further, the alteration and adjustment module 219 adjusts the values of each of the ratio to update the predefined threshold boundary of the corresponding one or more resources 102 in real-time. When the values are adjusted, the corresponding predefined threshold boundary of the ratio of the request and provision is adjusted such that the one or more transactions 103 are performed efficiently. Thus, the request and provision associated with the one or more transactions 103 corresponding to the one or more resource 102 is regulated. In an embodiment, the predefined threshold boundary is adjusted when the insertion of the one or more additional contexts influence changes in the value of the ratio.

In an embodiment, the other modules 220 may include display module, notification module, etc.

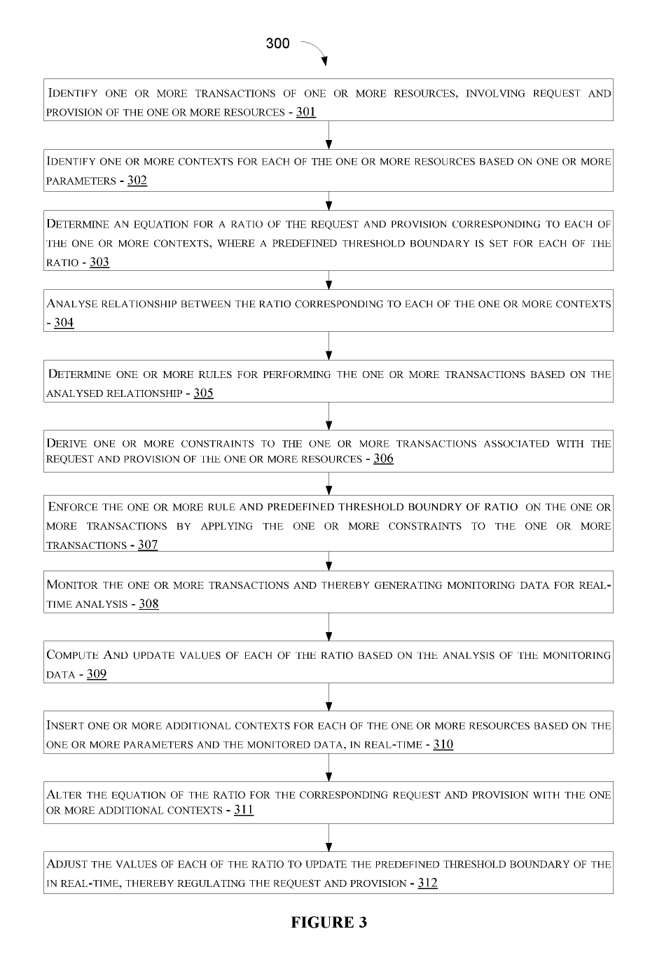

FIG. 3 shows a flow chart illustrating a method for regulating request and provision of the one or resources 102 associated with the one or more transactions 103.

As illustrated in FIG. 3, the method 300 may comprise one or more steps for regulating request and provision of the one or more resources 102 associated with the one or more transactions 103. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At step 301, the identification module 212 identifies one or more transactions 103 of the one or more resources 102, involving request and provision of the one or more resources 102. Consider a scenario where a user requests for a resource and transaction is made to provide the resource to the user. The identification module 212 identifies such transactions involving request and provision of the resource.

At step 302, the identification module 212 identifies the one or more contexts for each of the one or more resources 102 based on the one or more parameters. Each of the one or more transactions 103 are contextualized for deriving efficient ratio of request and provision of the one or more resources 102. Thus, the identification module 212 identifies the one or more contexts based on the one or more parameters. The one or more parameters comprises at least one of one or more participants of smart city resource governance system 101, characteristics of the one or more resources 102, association of the one or more participants, coverage vicinity of the one or more participants, and utilization of the one or more resources 102 by one or more participants. The characteristics of the one or more resources 102 may include type of resource, availability of resource, etc.

At step 303, the determination and analysis module 213 determines the equation for the ratio of the request and provision corresponding to each of the one or more contexts. The equation is determined by equating the ratio of request and provision based on at least one of the one or more contexts, the one or more participants performing transactions corresponding to the resource, and identified one or more parameters. A predefined threshold boundary is set for each of the ratio by placing permissible values of the corresponding one or more contexts. The predefined threshold boundary comprises an upper limit value and a lower limit value. The upper limit value indicates maximum requesting and provisioning capacity and the lower limit value indicates minimum requesting and provisioning capacity.

At step 304, the determination and analysis module 213 analyses relationship between ratio corresponding to each of the one or more contexts. Further, the determination and analysis module 213 analyses relationship between the ratio corresponding to each of the one or more contexts. Here, the relationship conveys interdependency of the one or more resources 102 on each other. Also, the relationship helps determine external impact on the one or more resources 102.

At step 305, the determination and analysis module 213 determines one or more rules for performing the one or more transactions 103 based on the analysed relationship. The one or more rules are mapped to the ratio corresponding to each of the one or more contexts. Further, the determination and analysis module 213 determines sub rules related to the ratio.

In an embodiment, the determination and analysis module 213 can create the one or more rules, delete the one or more rules, read the one or more rules, update the one or more rules or perform any operation related to the one or more rules.

At step 306, the derivation module 214 derives the one or more constraints to the one or more transactions 103 associated with the request and provision of the one or more resources 102. Here, the one or more constraints are derived to specify particular way of operation of the one or more transactions 103. The one or more constraints are derived based on the predefined threshold boundary of the ratio, the one or more rules and type of the one or more transactions 103.

At step 307, the enforcement module 215 enforces the one or more rules and the one or more predefined threshold boundary of ratio on the one or more transactions 103 by applying the one or more constraints on the one or more transactions 103. Here, the one or more constraints are automatically applied on the one or more transactions 103, which may result in alteration of request to provision ratio of the resource in consideration, based on the predefined threshold boundary. Here, for a given type of one or more resource 103, the one or more constraints are applied automatically on the one or more transactions 103 for the one or more resources 102. The one or more constraints are applied based on the predefined threshold boundary corresponding to the ratio associated with the one or more contexts associated with the one or more resources 102.

At step 308, the monitoring module 216 monitors the one or more transactions 103. Once the one or more rules are enforced on the one or more transactions 103, the monitoring module 216 monitors the one or more transactions 103. Further, the monitoring module 216 generates the monitoring data for the monitored one or more transactions 103. The monitoring data may include information related to completion of the one or more transactions 103, correctness of the one or more transactions 103, sufficiency of the one or more transactions 103, etc. In an embodiment, the request and provision associated with the one or more resources 102 are monitored based on the equation of the ratio of request and provision.

In an embodiment, one or more performance indicators are used for monitoring. For example, the performance indicators may be wastage indicator, recycle indicator, average retention indicator, etc.

At step 309, the computation module 217 computes and updates values of each of the ratio based on the monitored data. Here, the values represent present value of the request to provision ratio of the resource in smart city 100. The values are computed at runtime to regulate the request and provision of the one or more resources 102 associated with the one or more transactions 103.

At step 310, the insertion module 218 inserts one or more additional contexts for each of the one or more resources 102 based on the one or more parameters and the monitored data. The one or more additional contexts are inserted to mitigate transaction loss based on the analysis of the monitored data, i.e., when the initially considered one or more contexts do not amount to efficient working of the one or more transactions 103, the one or more additional contexts are inserted. Here, transaction loss may include wastage of the one or more resources 102, over-supply of the one or more resources 102, under-supply of the one or more resources 102, wrong supply of the one or more resources 102, etc.

At step 311, the alteration and adjustment module 219 alters the equation of the ratio for the corresponding request and provision with the one or more additional contexts. When the one or more additional contexts are inserted, the equation is altered in consideration of the one or more additionally inserted contexts. The one or more additional contexts refine the equation.

At step 312, the alteration and adjustment module 219 adjusts the values of each of the ratio to update the predefined threshold boundary of the corresponding one or more resources 102 in real-time. The predefined threshold boundary is updated by placing the value to the ratio and it is enforced by the one or more constraints based on the altered equation of the ratio of the request and provision. When the values are adjusted, the corresponding predefined threshold boundary of the ratio of the request and provision is adjusted such that the one or more transactions 103 are performed efficiently. Thus, the request and provision associated with the one or more transactions 103 corresponding to the one or more resource 102 is regulated.

Consider an example of food supply-chain where different categories and types of products are identified. Foods are of different type, examples of types of food may include but are not limited to, organic vegetables, dairy products, cereals, meat products, and canned vegetables. Different types of foods can have similarities and differences in dimensions. In an embodiment, the one or more contexts may have dimensions. The dimensions to categories of contexts that can be inserted are products' or services' offerings association, providers' association, consumers' association, and coverage associations. Further, similarities in the dimensions are determined. From the example, cereals and canned foods are both processed food and typically available to same retail locations supplied by multiple providers. Likewise, the organic vegetables, the dairy products, the cereals, and the canned vegetables are consumed by same set of users 104 within same vicinity of the smart city 100. The dissimilarities in dimensions may be producers and distributors are different Calories, ingredients, and vitamins that the foods are providing differs from each other.

The one or more contexts that may be used in case of canned vegetables may be daily consumption, daily supplies, brands, providers, stock, items returned, average retention, recycle indicator, wastage indicator, preservative level, etc. The one or more contexts in case of canned vegetables may include number of daily items supplied, brand, provider, number of items in stock, number of items returned in specified timeframe, average retention, maximum retention, recycle indicator, wastage indicator, preservative level, etc.

The example of the relationship that needs to be defined in the case of canned vegetables is between the daily consumptions, daily supplies, recycle indicator, wastage indicator, average retention, and maximum retention. Recycle indicator provides finite value of product items (that are in stock) including packaging and food can be recycled. Average retention indicates the present average retention of overall stock for the specific one or more resources 102. Wastage indicator provides the finite value of the one or more resources 102 that are wasted on the daily basis. The ratio for canned vegetable includes the ratio of recycle indicator to wastage indicator, the daily consumption to daily supplies, and average retention to maximum retention. Consider an example of canned corns. If the daily consumption is 2000 units across the smart city 100, daily supply is 2225 units, average retention of all the present canned corns at all the stores pertaining to the smart city 100 is 5 days. If the maximum retention for canned corns is 10 days, the recycle indicator for canned corns is 65%, and wastage indicator is 35% then the ratio can be computed as follows.

Present ratio of canned corn=(Daily consumption/Daily supplies)×(Recycle Indicator/Wastage indicator)×(Maximum Retention/Average Retention)

The present value of the ratio in above scenario is ((2000/2225)×(0.65/0.35)×(10/5)).

Although the one or more contexts are similar in the categories of processed food (example: canned vegetables and cereals), value of the ratio associated with each of the contexts differs from each other. Further, an equation is determined based on the ratio. Here, the ratio is equated to the one or more contexts, where the equation provides information on variation of the ratio with respect to the one or more contexts. Further, a relationship between each of the ratio is determined. Let us consider that for a particular brand, the wastage of cereals is more. Thus, a relationship can be derived that for the particular brand, the wastage is more. Likewise, a relationship is determined between each of the one or more contexts. Based on the relationship, one or more rules are determined for performing one or more transactions 103 of the food. For example, an organization provides advice on healthful eating, including consuming diet, rich in a variety of fruits and vegetables, through a guidance system. In response, statistics of consumption data show that users are eating more fresh produce. Fresh-cut sector of the produce industry is its fastest growing segment. As the fresh-cut produce market continues to grow, the processors of such produce in the smart city 100 are faced with the challenge of processing an increasing variety and volume of resources in a manner that ensures the safety and qualitative rules of these resources to avoid food related sickness to the consumers through the smart city 100. For example, the maximum level of contamination set for variety of fresh-cut vegetable and it needs to be enforced.

Further, one or more constraints are derived based on the one or more rules. For example, a constraint may be added that the canned foods must be delivered to retailer only after 3 μm. Likewise a constraint may be added that vegetables must be supplied before 10 am. Further, the one or more constraints are applied on the one or more transactions 103 and the one or more rules are enforced. With the applied one or more constraints the one or more transactions 103 are performed and the one or more transactions 103 are monitored. For example, let the monitored data indicate that the vegetables are supplied even after 10 am. The monitored data is analysed and causes for inefficiency in the one or more transactions 103 are determined. Let us assume that route chosen for supply of the vegetables is a long path. Based on the analysis, further constraints may be imposed, i.e., a specific route to be followed for supplying vegetables to a particular retailer. Also, additional contexts may be inserted to the ratio based on the analysis of the monitored data. Let us assume that the analysis provides that vegetables are wasted on a large scale on a daily basis. Thus, such vegetables are identified and provision of such vegetables are regulated. Similarly, when there is scarcity of provision of certain resources 102, steps are taken to increase provision of such resources 102. The increase or decrease in provision of the one or more resources 102 are determined by altering values of the predefined threshold boundary values. Thus, the provisioning of the one or more resources 102 are always at par with the request of the one or more resources 102. Thus, the request and provision of the one or more resources 102 are regulated.

In an embodiment, the one or more transactions 103 may be successful transactions or unsuccessful transactions. In an embodiment, the ratio related to successful transactions are updated.

### Computer System

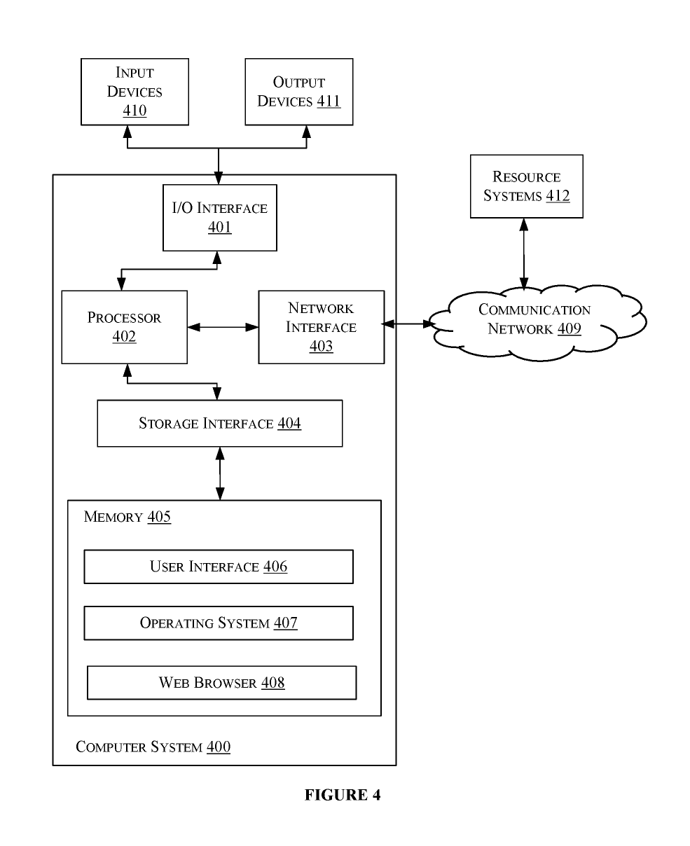

FIG. 4 illustrates a block diagram of an exemplary computer system 400 for implementing embodiments consistent with the present disclosure. In an embodiment, the computer system 400 is used to implement the method for regulating request and provision of resources associated with transactions in a region. The computer system 400 may comprise a central processing unit (“CPU” or “processor”) 402. The processor 402 may comprise at least one data processor for executing program components for dynamic resource allocation at run time. The processor 402 may include specialized processing units such as integrated system (bus) controllers, memory management control units, floating point units, graphics processing units, digital signal processing units, etc.

The processor 402 may be disposed in communication with one or more input/output (I/O) devices (not shown) via I/O interface 401. The I/O interface 401 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the computer system 400 may communicate with one or more I/O devices. For example, the input device 410 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 411 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 400 is connected to the service operator through a communication network 409. The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network 409 may include, without limitation, a direct interconnection, e-commerce network, a peer to peer (P2P) network, local area network (LAN), wide area network (WAN), wireless network (e.g., using Wireless Application Protocol), the Internet, Wi-Fi, etc. Using the network interface 403 and the communication network 409, the computer system 400 may communicate with the one or more service operators.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, web browser 408 etc. In some embodiments, computer system 400 may store user/application data 406, such as the data, variables, records, etc. as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, 10 etc.), Apple iOS, Google Android, Blackberry OS, or the like.

In some embodiments, the computer system 400 may implement a web browser 408 stored program component. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

In an embodiment, the computer system 400 may interact with the resource systems 412 for enforcing the one or more rules and constraints on the one or more transactions 103. Thus, request and provision of the one or more resources 102 are regulated.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

In an embodiment, the smart city resource governance system provides a common framework to support collaboration, between different providers in the smart city and different standards bodies.

In an embodiment, the smart city resource governance system ensures that the smart city manages issues such as resilience of supply chain, product streams and demand workflows at a whole-system level.

In an embodiment, the contextualization of request and provision ratio helps the smart city evaluate how well the ratio is used for progress of the smart city in becoming smarter and reducing loss or wastages across the smart city proximities.

In an embodiment, the smart city resource governance system ensures interoperability between different smart city systems to precisely indicate request and provision of the resources.

In an embodiment, the smart city resource governance system provides insights on understanding complexities and interrelating issues relating to growth towards a smarter city. Also, the smart city resource governance system enables to understand how to put together right standards and transaction level rules requirements to ensure request and provision.

In an embodiment, the smart city resource governance system provides interfaces between public sector, commercial organizations (small, medium, large), and consumers to indicate the availability of the smart city resources.

In an embodiment, consistency in trading protocols within the smart city and their association with other cities are maintained.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of regulating request and provision of resources associated with transactions in a region implemented by one or more smart city resource governance computing device, the method comprising:
identifying one or more transactions for one or more resources relating to requesting or provisioning of the one or more resources and one or more contexts for each of the resources based on one or more parameters;
determining one or more ratios of the requesting or provisioning corresponding to each of the contexts, wherein a predefined threshold boundary is set for each of the ratios;
determining one or more rules for performing the transactions based on a relationship between the ratios corresponding to each of the contexts;
deriving one or more constraints for the transactions associated with the requesting or provisioning of the one or more resources based on the predefined threshold boundary, the rules, and a type of the transactions; and
applying the constraints to the transactions in order to enforce the rules on the transactions and regulate the requesting or provisioning of the resources associated with transactions.

2. The method of claim 1, further comprising:
monitoring the transactions to generate monitoring data;
computing values of each of the ratios based on a real-time analysis of the monitoring data;
inserting one or more additional contexts for each of the resources based on the parameters and the monitoring data, in real-time;
altering one or more of the ratios for a corresponding one of the requesting or provisioning with the additional contexts; and
adjusting the values of each of the ratios to update the predefined threshold boundary of the corresponding resources in real-time.

3. The method of claim 2, wherein the requesting or provisioning associated with the one or more resources is monitored based on the ratios of the requesting or provisioning.

4. The method of claim 1, further comprising determining an impact of the requesting or provisioning associated with the resources on the contexts.

5. The method of claim 1, wherein the one or more parameters comprise one or more participants, one or more characteristics of the resources, an association of one or more of the participants, a coverage vicinity of one or more of the participants, or a utilization of the resources by one or more of the participants.

6. The method of claim 2, further comprising updating the rules based on the relationship between the ratios corresponding to the additional contexts in real-time.

7. A smart city resource governance computing device comprising a memory comprising programmed instructions stored thereon and one or more processors coupled to the memory and configured to be capable of executing the stored programmed instructions to:
identify one or more transactions for one or more resources relating to requesting or provisioning of the one or more resources and one or more contexts for each of the resources based on one or more parameters;
determine one or more ratios of the requesting or provisioning corresponding to each of the contexts, wherein a predefined threshold boundary is set for each of the ratios;
determine one or more rules for performing the transactions based on a relationship between the ratios corresponding to each of the contexts;
derive one or more constraints for the transactions associated with the requesting or provisioning of the one or more resources based on the predefined threshold boundary, the rules, and a type of the transactions; and
apply the constraints to the transactions in order to enforce the rules on the transactions and regulate the requesting or provisioning of the resources associated with transactions.

8. The smart city resource governance computing device of claim 7, wherein the one or more processors are further configured to be capable of executing the stored programmed instructions to:
monitor the transactions to generate monitoring data;
compute values of each of the ratios based on a real-time analysis of the monitoring data;
insert one or more additional contexts for each of the resources based on the parameters and the monitoring data, in real-time;
alter one or more of the ratios for a corresponding one of the requesting or provisioning with the additional contexts; and
adjust the values of each of the ratios to update the predefined threshold boundary of the corresponding resources in real-time.

9. The smart city resource governance computing device of claim 8, wherein the requesting or provisioning associated with the one or more resources is monitored based on the ratios of the requesting or provisioning.

10. The smart city resource governance computing device of claim 7, wherein the one or more processors are further configured to be capable of executing the stored programmed instructions to determine an impact of the requesting or provisioning associated with the resources on the contexts.

11. The smart city resource governance computing device of claim 7, wherein the one or more parameters comprise one or more participants, one or more characteristics of the resources, an association of one or more of the participants, a coverage vicinity of one or more of the participants, or a utilization of the resources by one or more of the participants.

12. The smart city resource governance computing device of claim 8, wherein the one or more processors are further configured to be capable of executing the stored programmed instructions to update the rules based on the relationship between the ratios corresponding to the additional contexts in real-time.

13. A non-transitory computer readable medium comprising programmed instructions stored thereon that when executed by one or more processors cause the one or more processors to:
identify one or more transactions for one or more resources relating to requesting or provisioning of the one or more resources and one or more contexts for each of the resources based on one or more parameters;
determine one or more ratios of the requesting or provisioning corresponding to each of the contexts, wherein a predefined threshold boundary is set for each of the ratios;
determine one or more rules for performing the transactions based on a relationship between the ratios corresponding to each of the contexts;
derive one or more constraints for the transactions associated with the requesting or provisioning of the one or more resources based on the predefined threshold boundary, the rules, and a type of the transactions; and
apply the constraints to the transactions in order to enforce the rules on the transactions and regulate the requesting or provisioning of the resources associated with transactions.

14. The non-transitory computer readable medium of claim 13, wherein the programmed instructions, when executed by the one or more processors, further cause the one or more processors to
monitor the transactions to generate monitoring data;
compute values of each of the ratios based on a real-time analysis of the monitoring data;
insert one or more additional contexts for each of the resources based on the parameters and the monitoring data, in real-time;
alter one or more of the ratios for a corresponding one of the requesting or provisioning with the additional contexts; and
adjust the values of each of the ratios to update the predefined threshold boundary of the corresponding resources in real-time.

15. The non-transitory computer readable medium of claim 14, wherein the requesting or provisioning associated with the one or more resources is monitored based on the ratios of the requesting or provisioning.

16. The non-transitory computer readable medium of claim 13, wherein the programmed instructions, when executed by the one or more processors, further cause the one or more processors to determine an impact of the requesting or provisioning associated with the resources on the contexts.

17. The non-transitory computer readable medium of claim 13, wherein the one or more parameters comprise one or more participants, one or more characteristics of the resources, an association of one or more of the participants, a coverage vicinity of one or more of the participants, or a utilization of the resources by one or more of the participants.

18. The non-transitory computer readable medium of claim 14, wherein the programmed instructions, when executed by the one or more processors, further cause the one or more processors to update the rules based on the relationship between the ratios corresponding to the additional contexts in real-time.
